(19) United States
(12) Patent Application Publication
(10) Pub. No.: US 2004/0032964 A1
(43) Pub. Date: Feb. 19, 2004

(54) Sound-surrounding headphone

(76) Inventor: Wen-Kuang Liang, Taoyuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/216,738

(22) Filed: Aug. 13, 2002

(51) Int. Cl. H04R 25/00

(52) U.S. Cl. 381/370; 381/371; 381/374; 381/376; 381/378

(57) ABSTRACT

A headphone includes two earphones attached to a headband by flexible adjusting bands for properly positioning and orienting the earphones with respect to ears of a wearer. Each earphone has a casing inside which a front-position speaker, a rear-position speaker, a middle-position speaker between the front-position and rear-position speakers and a lower-position speaker below the front-position, rear-position and middle-position speakers are arranged. The headband forms a casing inside which two top-position speakers are mounted, respectively associated with the earphones. The speakers are arranged to generate a multi-channel surrounding sound. The headphone also forms a chamber inside which a fan is fixed for generation of airflow to remove heat from the wearer.

### BACKGROUND OF THE INVENTION

1. Field of the Invention

The present invention generally relates to a headphone, and in particular to a headphone that provides sound surrounding effect for generating stereoscopic and enhanced audio experience for a wearer and incorporates heat dissipation device for wearer's comfort.

2. The Related Art

Multi-channel speaker systems comprised of a number of speakers located at different positions and orientations are widely used in for example home cinema systems, electronic game systems and in-car audio systems for generation of stereoscopic sound and high fidelity effect. However, since a number of differently positioned and oriented speakers are employed in such high fidelity systems, a substantial amount of space is required for accommodating the speakers. Further, a listener must be located at a precise location surrounded by the speakers in order to obtain good stereoscopic audio result. Thus, the listener is not allowed to move freely if he or she wishes to have excellent high fidelity surrounding sound.

Thus, it is desired to have a device for overcoming the above deficiencies of the currently available stereoscopic sound playing devices.

### SUMMARY OF THE INVENTION

An object of the present invention is to provide a headphone comprising a plurality of speakers arranged for generating a multi-channel surrounding sound to a wearer.

Another object of the present invention is to provide a multi-channel sound-surrounding headphone that allows a wearer to move freely without degrading high fidelity effect thereof.

A further object of the present invention is to provide a headphone incorporating a heat removing unit for providing cooling down to a wearer whereby comfort of the wearer in long-term wearing the headphone is enhanced.

To achieve the above objects, in accordance with the present invention, there is provided a multi-channel sound-surrounding headphone comprising two earphones attached to a headband by flexible adjusting bands for properly positioning and orienting the earphones with respect to ears of a wearer. Each earphone has a casing inside which a front-position speaker, a rear-position speaker, a middle-position speaker between the front-position and rear-position speakers and a lower-position speaker below the front-position, rear-position and middle-position speakers are arranged. The headband forms a casing inside which two top-position speakers are mounted, respectively associated with the earphones. The speakers are arranged to generate a multi-channel surrounding sound. The headphone also forms a chamber inside which a fan is fixed for generation of airflow to remove heat from the wearer.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a headphone constructed in accordance with the present invention;

FIG. 2 is a bottom view of the headphone of the present invention;

FIG. 3 is a cross-sectional view of the headphone of the present invention;

FIG. 4 is a front view of the headphone of the present invention; and

FIG. 5 is a perspective view of a headphone constructed in accordance with another embodiment of the present invention.

### DETAILED DESCRIPTION OF THE PREFERRED EMBODIMENTS

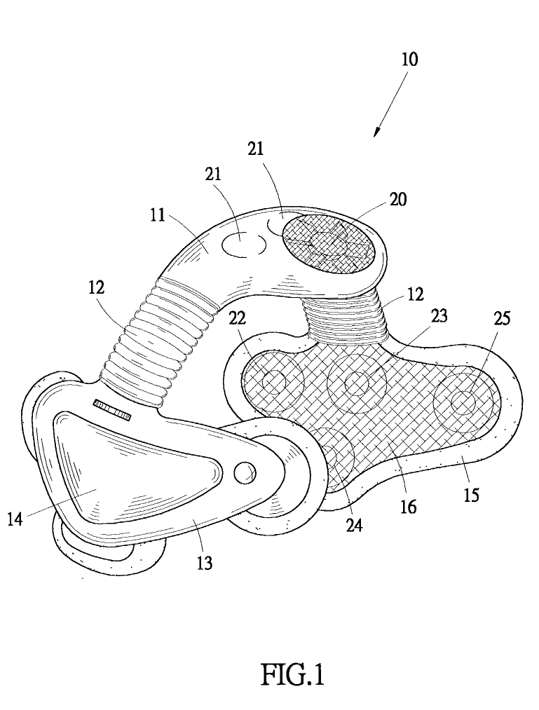

With reference to the drawings and in particular to FIGS. 1-4, a headphone constructed in accordance with the present invention, generally designated with reference numeral 10, comprises two earphones 13 respectively attached to a headband 11 by an adjusting band 12. The headphone 10 is worn whereby the earphones 13 respectively correspond to and engage left and right ears of a wearer (not shown). The adjusting bands 12 allow adjustment of the relative position and orientation of the earphones 13 with respect to the headband 11.

The earphones 13 comprise a casing (not labeled) defining an interior space for accommodation of a plurality of speakers 22-25 and forming a resonant chamber 14 for better audio effect and enhanced sound quality. The speakers 22-25 are arranged so that the speaker 22 is located at a front position, the speaker 23 at a middle position, the speaker 25 at a rear position and the speaker 24 at a lower position with respect to the speakers 22, 23, 25. The speakers 22-25 are arranged to generate a multi-channel, surrounding sound to the wearer.

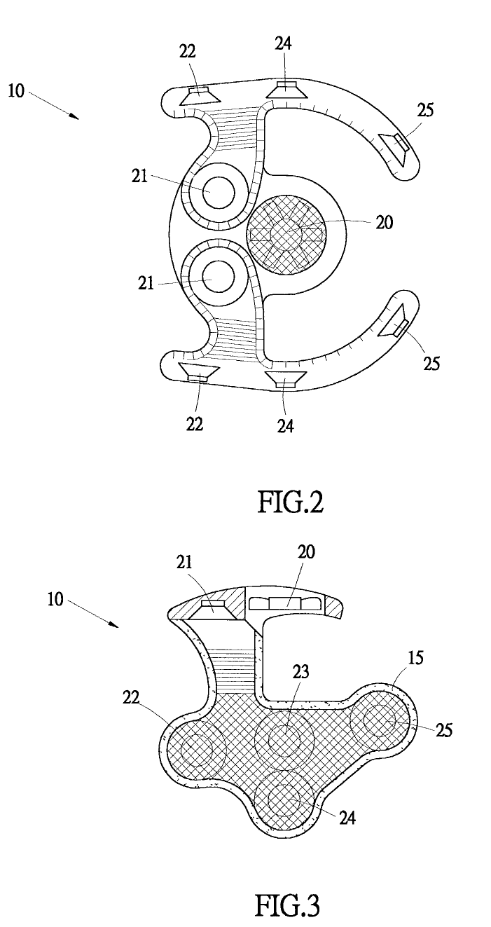

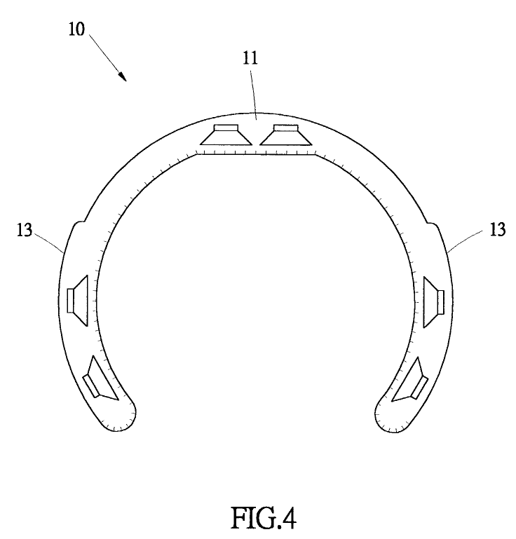

The headband 11 comprises a casing (not labeled) defining an interior space for accommodation of two speakers 21, respectively associated with the earphones 13. The speakers 21 are provided to enhance or realize the multi-channel surrounding sound of the associated earphones 13. As can be apparent from FIGS. 2 and 4, the speakers 21-25 are located in such a way to substantially surround the head of the wearer.

As is known, the speakers 21-25 can be of any frequencies, such as a tweeter, a super-tweeter, a squawker (or midrange), a woofer and a subwoofer. The arrangement of the frequency of these speakers is apparent to those having ordinary in stereoscopic sound displaying field and is not part of the novelty of the present invention. Thus, the arrangement of the speakers 21-25 inside the casings of the headband 11 and the earphones 13 will not be further discussed herein.

The casing of the headband 11 also forms a chamber (not labeled) inside which a fan or other heat removing unit 20 is mounted. The fan chamber extends completely through the headband 11 as shown in FIG. 3 thereby defining a passageway for air flow caused by the fan 20. The air flow removes heat from the head of the wearer and thus making the wearer comfort in long term use of the headphone 10.

The adjusting bands 12 comprise members that are capable of repeated plastic deformation for properly positioning and orienting the earphones 13 for different wearers. Since such a technique is well known, no further detail regarding the adjusting bands 12 is needed herein.

The headphone 10 can be connected to an audio source (not shown) by a conventional connecting cable (not shown). Alternatively, the headphone 10 can be a wireless device that requires no cable connection with the audio source.

Preferably, an ear pad or ear cushion 15 made of a resilient material is attached to each earphone 13 for wearer's comfort in wearing the headphone 10.

Grilles 16 are mounted to the casings of the headband 11 and the earphones 13 for protection and separation of the speakers 21-25 and the fan 20 from external objects and the head of the wearer.

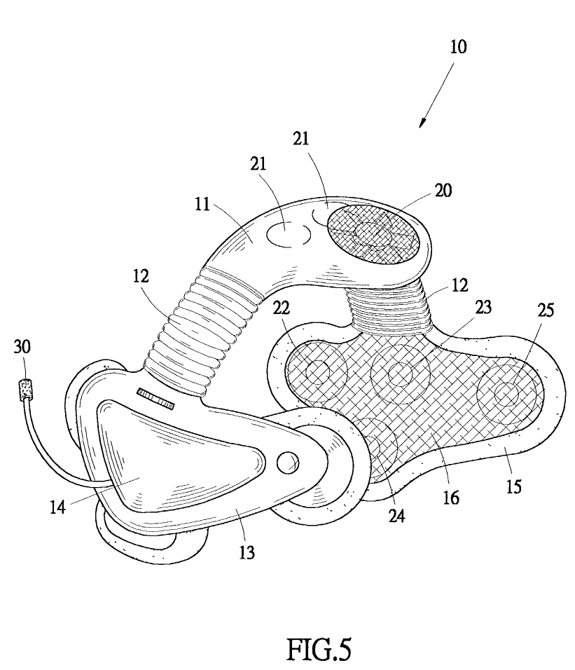

If desired, a microphone 30 may be attached to the headphone 10 as illustrated in FIG. 5. The microphone 30 is attached to the headphone 10 by a flexible member (not labeled) that allows adjustment

of the relative position of the microphone 30 with respect to the mouth of the wearer.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A headphone comprising:
an earphone comprising a number of speakers arranged inside a casing of the earphone; and
a headband to which the earphone is attached by a flexible adjusting band whereby the headphone is positionable around a head of a wearer with the earphone engaging an ear of the wearer, the speakers being arranged to generate a surrounding sound to the wearer.

2. The headphone as claimed in claim 1, wherein the speakers that are arranged inside the earphone casing comprises a speaker located at a front position, a speaker at a rear position, a speaker at a middle position between the front and rear position speakers and a speaker at a lower position with respect to the front, rear and middle position speakers.

3. The headphone as claimed in claim 1, wherein the headband comprises a casing inside which an additional speaker is arranged, the speaker being associated with the speakers of the earphone to generate the surrounding sound.

4. The headphone as claimed in claim 1, wherein two earphones each comprising a plurality of speakers are attached to the headband by adjusting bands whereby position and orientation of the earphones are adjustable by means of the adjusting bands to correspond to and engage ears of the wearer.

5. The headphone as claimed in claim 4, wherein the headband comprises a casing inside which two additional speakers are arranged, respectively associated with the earphones to generate the surrounding sound.

6. The headphone as claimed in claim 1, wherein the headband forms a chamber inside which a heat removing unit is fixed for removing heat from the wearer.

7. The headphone as claimed in claim 6, wherein the heat removing unit comprises a fan and wherein the chamber extends completely through the headband for forming a passage for air flow caused by the fan.

8. The headphone as claimed in claim 1 further comprising a microphone attached to the headphone by a flexible member for positioning the microphone with respect to mouth of the wearer.

9. The headphone as claimed in claim 1, wherein the earphone forms a resonant chamber for enhancing sound quality.

10. The headphone as claimed in claim 1, wherein the casing of the earphone comprises a grille for protection and separation the speakers from external objects.

11. The headphone as claimed in claim 3, wherein the casing of the headband comprises a grille for protection and separation the additional speaker from external objects.

12. The headphone as claimed in claim 7, wherein the headband comprises a grille for protection and separation the fan from external objects.

13. The headphone as claimed in claim 1, wherein the earphone comprises an ear cushion for comfort of the wearer.
